(19) United States
(12) Patent Application Publication
(10) Pub. No.: US 2008/0052520 A1
(43) Pub. Date: Feb. 28, 2008

(54) SYSTEM AND METHOD FOR VERIFYING ELECTRONIC SIGNATURE OF A DOCUMENT

(75) Inventors: CHUNG-I LEE, Tu-Cheng (TW); HAI-HONG LIN, Shenzhen (CN); GUO-LING OU-YANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/615,945

(22) Filed: Dec. 23, 2006

(30) Foreign Application Priority Data
Aug. 28, 2006 (CN) 200610200825.3

(51) Int. Cl. H04L 9/00

(52) U.S. Cl. 713/176

(57) ABSTRACT

A computer-based method for verifying electronic signature of a document is provided. The method includes the steps of: generating a first document by a first party in a server; encrypting the first document in the server; sending the first document to a client and informing a second party of signing the document electronically; signing the first document by the second party electronically in the client to generate a second document; receiving the second document sent from the client by the server and decrypting the second document; determining whether the contents of the second document are the same as the contents of the first document; and verifying whether the signatory of the second document is the designated signatory if the contents of the second document are the same as the contents of the first document. A related system is also disclosed.

### BACKGROUND OF THE INVENTION

1. Field of the Invention

The present invention generally relates to systems and methods for verifying signatures, and more particularly to a system and method for verifying electronic signature of a document.

2. General Background

In paper-based system, handwritten pen-on-paper signatures have been the basis of contracts in commerce for hundreds of years, for a variety of reasons, including:

### (1) The signature and documents are of the same, being forever bound together with the ink on the paper;

### (2) The identity of the signer can be verified after the fact by a trained forensic document examiner who is skilled in the art and science of signature character analysis, and who can testify, be qualified, and be cross-examined in a court of law; and

### (3) The signer can keep a copy or duplicate original of the contract to deter fraud.

As enterprises move from paper-based systems to more economical paperless environments, new barriers presented must be overcome with new technology. Business transactions, agreements and authorizations that require one or more person's assent, are evidenced by that person's signature, which must be electronically perpetuated in a paperless system. Perpetuation is required to maintain the commercial quality of permanence that is required to support audit, evidentiary and enforcement requirements.

In October 2000, the federal Electronic Signatures in Global and National Commerce Act (also known as “E-Sign”) was enacted. The new law broadly authorizes electronic records and electronic signatures as being legally effective. The existence of this new law makes business transactions conducted electronically easier to enforce. Therefore, a major barrier for conducting electronic business transactions has been removed, and greater proliferation of electronic business transactions will no doubt be seen in the marketplace.

However, in the existing electronic signatures system, the technique for verifying the electronic signatures is not very perfect. Verifying whether the document has been altered, and verifying whether the signatory that sign the document is the designated signatory, these need to be made manually. The efficiency is very low and mistakes happen frequently.

### SUMMARY OF THE INVENTION

A system for verifying electronic signature of a document is provided. The system includes a server accessible by a first party of the document and a client accessible by a second party of the document. The server includes: a document generation module configured for generating a first document to be signed by the second party; an encryption module configured for encrypting the first document; a sending module configured for sending the first document to the client and informing the second party of signing the document electronically; a receiving module configured for receiving a second document electronically signed by the second party and sent from the client; a decryption module configured for decrypting the second document; and a verification module configured for determining whether the contents of the second document are the same as the contents of the first document, and verifying whether the signatory of the second document is the designated signatory.

Another preferred embodiment provides a computer-based method for verifying electronic signature of a document. The method includes the steps of: generating a first document by a first party in a server; encrypting the first document in the server; sending the first document to a client and informing a second party of signing the document electronically; signing the first document by the second party electronically in the client to generate a second document; receiving the second document sent from the client by the server and decrypting the second document; determining whether the contents of the second document are the same as the contents of the first document; and verifying whether the signatory of the second document is the designated signatory if the contents of the second document are the same as the contents of the first document.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of hardware configuration of a system for verifying electronic signature of a document in accordance with a preferred embodiment; and

FIG. 2 is a flowchart illustrating a method for verifying electronic signature of a document in accordance with a preferred embodiment.

### DETAILED DESCRIPTION OF THE INVENTION

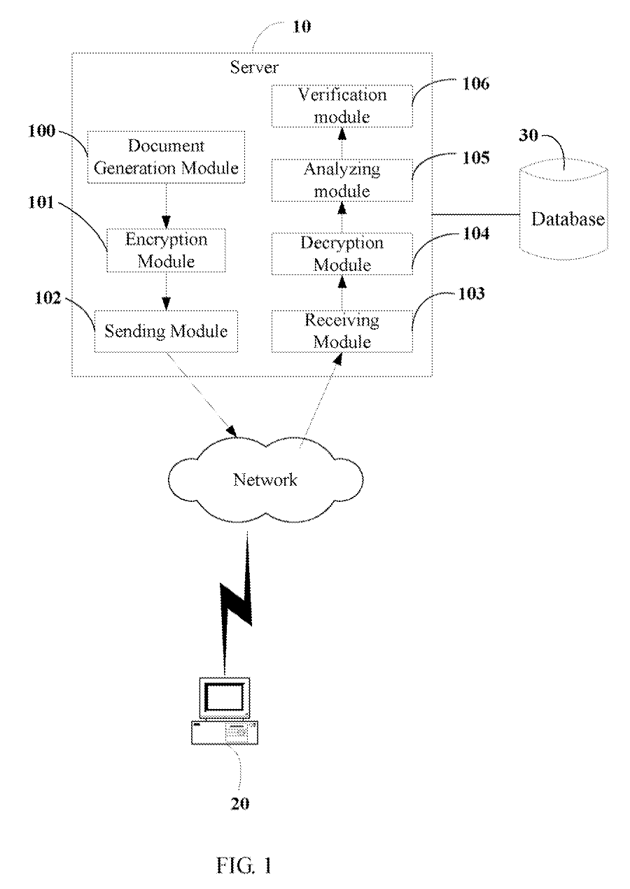

FIG. 1 is a schematic diagram of hardware configuration of a system for verifying electronic signature of a document (hereinafter “the system”), in accordance with a preferred embodiment. The system typically includes a server 10 accessible by a first party of the document and at least one client 20 accessible by a second party of the document. The server 10 connects with the client 20 via a network.

Furthermore, the system may also include a database 30, which connects with the server 10. The database 30 may store a digital certificate of the first party and a public key of a designated signatory of a document generated by the server 10. Typically, the public key of the designated signatory may be obtained indirectly or directly from a public key certificate of the designated signatory. The public key certificate is an electronic data object including the public key, and can be issued by a trusted third party, such as a certificate authority (CA) that verifies the identity of a certificate owner. The public key certificate can also include name of the CA and the certificate owner. The public key certificate of the designated signatory can be obtained in a number of ways, for instance, the first party can find the public key certificate in a searchable database on a server, or the certificate owner can include the public key certificate as an attachment to an e-mail message sent to the first party.

The server 10 includes a plurality of function modules, such as a document generation module 100, an encryption module 101, a sending module 102, a receiving module 103, a decryption module 104, an analyzing module 105, and a verification module 106.

The document generation module 100 is mainly configured for generating a first document to be signed by the second party. The first document may be electronic contract, or any other files. The format of the first document may be .pdf, .doc, .xls, and so on.

The encryption module 101 is mainly configured for encrypting the first document by utilizing a key (public key or secret key) of the digital certificate of the first party, to assure that the first document is not changed during transmission in the network. The cryptographic algorithm of encrypting the first document may be one of MD5 (Message-Digest Algorithm 5), ECC (Error Checking and Correcting), RSA, and so on.

The sending module 102 is mainly configured for sending the first document to the client 20, and informing the second party of signing the first document electronically through the client 20.

The receiving module 103 is mainly configure for receiving a second document sent by the client 20. Herein, the second document is the first document that has been electronically signed by the second party.

The decryption module 104 is mainly configured for decrypting the second document by utilizing the other key (secret key or public key) of the digital certificate of the first party.

The analyzing module 105 is configured for analyzing whether the signature of the second party in the second document is digital signature, and is also configured for analyzing the public key certificate of the second party to get the public key of the second party.

The verification module 106 is configured for determining whether the contents of the second document are the same as the contents of the first document, and is also configured for verifying whether the signatory of the second document is the designated signatory.

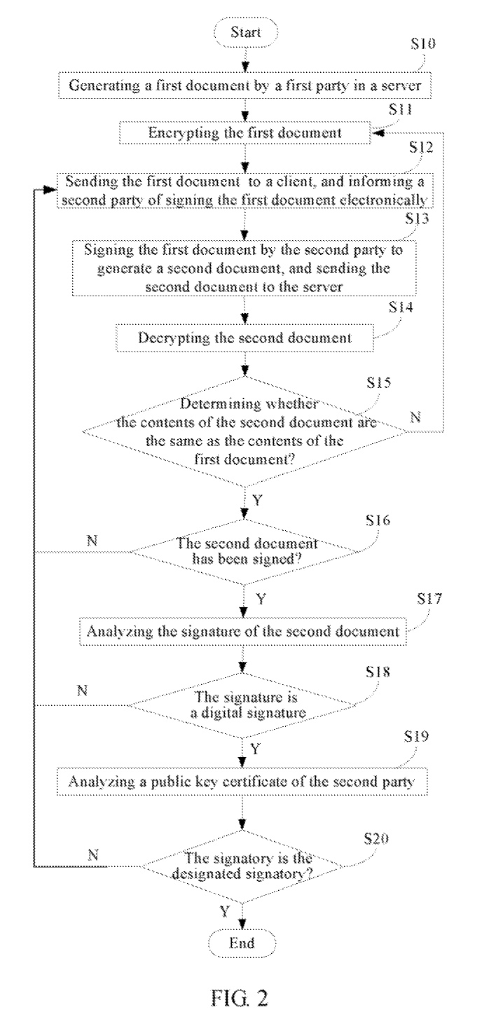

FIG. 2 is a flowchart illustrating a method for verifying electronic signature of a document in accordance with a preferred embodiment.

In step S10, the document generation module 100 generates a first document by the first party of the document in the server 10. The format of the first document may be .doc, .pdf, .xml, and so on.

In step S11, the encryption module 101 encrypts the first document by utilizing the secret key of the digital certificate of the first party.

In step S12, the sending module 102 sends the first document to the client 20, and informs a second party of the document of signing the first document electronically.

In step S13, the second party signs the first document electronically through the client 20 to generate a second document, and sends the second document to the server 10. The second party may send its public key certificate as an attachment of the second document to the server 10.

In step S14, the receiving module 104 receives the second document and the public key certificate of the second party, and the decryption module 104 decrypts the second document.

In step S15, the verification module 106 determines whether the contents of the second document are the same as the contents of the first document.

If the contents of the second document are not the same as the contents of the first document, the procedure returns to step S11 described above. Otherwise, if the contents of the second document are the same as the contents of the first document, in step S16, the verification module 106 verifies whether the second document has been signed, namely verifying whether the second document has an electronic signature. If the document does not have the electronic signature, the procedure returns to step S12 described above.

If the second document has the electronic signature, in step S17, the analyzing module 105 analyzes the electronic signature, and identifies the kind of the electronic signature. The electronic signature may be a digital signature based on public key infrastructure (PKI); or a distinguishing mark based on biology characteristic statistics; or an electronic image of signet and handwritten signature; or a password that distinguishes identity, and so on.

In step S18, the analyzing module 105 analyzes whether the electronic signature is a digital signature based on the PKI. If the electronic signature is not the digital signature, the procedure returns to step S12 described above.

If the electronic signature is the digital signature, in step S19, the analyzing module 105 analyzes the public key certificate of the second party to get the public key of the second party.

In step S20, the verification module 106 verifies whether the signatory of the second document is the designated signatory by comparing the public key of the second party with the public key of the designated signatory stored in the database 30.

If the two public keys are not identical, the signatory of the second document is not the designated signatory, and the procedure returns to step S12 described above.

If the two public keys are identical, the signatory of the second document is the designated signatory, and the procedure ends.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for verifying electronic signature of a document, the system comprising a server accessible by a first party of the document and a client accessible by a second party of the document, the server comprising:
a document generation module configured for generating a first document to be signed by the second party;
an encryption module configured for encrypting the first document;
a sending module configured for sending the first document to the client and informing the second party of signing the document electronically;
a receiving module configured for receiving a second document electronically signed by the second party and sent from the client;
a decryption module configured for decrypting the second document; and
a verification module configured for determining whether the contents of the second document are the same as the contents of the first document, and verifying whether the signatory of the second document is the designated signatory.

2. The system according to claim 1, wherein the receiving module is further configured for receiving a public key certificate of the second party as an attachment of the second document from the client.

3. The system according to claim 2, wherein the server further comprises an analyzing module configured for analyzing whether the signature of the second document is a digital signature and analyzing the public key certificate of the second party to get a public key of the second party.

4. The system according to claim 3, further comprising a database for storing a public key of the designated signatory of the first document and the public key certificate of the second party.

5. The system according to claim 4, wherein the verification module verifies whether the signatory of the second document is the designated signatory by comparing the public key of the designated signatory stored in the database with the public key of the second party.

6. A computer-based method for verifying electronic signature of a document, the method comprising the steps of:
generating a first document by a first party in a server;
encrypting the first document in the server;
sending the first document to a client and informing a second party of signing the document electronically;
signing the first document by the second party electronically in the client to generate a second document;
receiving the second document sent from the client by the server and decrypting the second document;
determining whether the contents of the second document are the same as the contents of the first document; and
verifying whether the signatory of the second document is the designated signatory if the contents of the second document are the same as the contents of the first document.

7. The method according to claim 6, wherein if the contents of the second document are not the same as the contents of the first document, the procedure returns to the encrypting step.

8. The method according to claim 6, further comprising receiving a public key certificate of the second party as an attachment of the second document sent from the client.

9. The method according to claim 8, further comprising before the verifying step:
analyzing whether the signature of the second document is a digital signature; and
analyzing the public key certificate of the second party to get a public key of the second party, if the signature is digital signature.

10. The method according to claim 9, wherein the verifying step is achieved by comparing a public key of the designated signatory stored in a database with the public key of the second party.

11. The method according to claim 9, wherein if the signatory of the second document is not the designated signatory, the procedure returns to the sending step.
